(19) United States
(12) Patent Application Publication
(10) Pub. No.: US 2005/0278698 A1
(43) Pub. Date: Dec. 15, 2005

(54) Multi-window based graphical user interface (GUI) for web applications

(76) Inventor: John Verco, New York, NY (US)

Correspondence Address: MEREDITH & KEYHANI. PLLC, 315 PARK AVENUE SOUTH, 19TH FLOOR, NEW YORK, NY, 10010, US

(21) Appl. No.: 10/770,729

(22) Filed: Feb. 2, 2004

Related U.S. Application Data
(60) Provisional application No. 60/444,613, filed on Feb. 3, 2003.

(51) Int. Cl. G09G 5/00; G06F 9/44

(52) U.S. Cl. 717/116

(57) ABSTRACT

It is envisioned that the present invention may be utilized as a system for transferring data across a network by means of a multi-window based GUI. The system comprises a remote server, having at least one window module, .NET application, .NET framework, .NET development tools, an HTML beginning tag, an HTML ending tag and at least one ASPX tag. The server translates classes and objects into HTML/DHTML code by taking the tag and embedding code to fit within the beginning and ending tag, then transferring the code across an electronic data network. The system includes at least one client system coupled to the server. The client has a content retrieval module in communication with the server and a web browser further comprising at least one window module and interactive menu module. The interactive menu module reacts to activation and posts back to the server through a raised event.

This application claims priority from Provisional Application 60/444,613, filed Feb. 3, 2003, entitled “Machine and process for creating and maintaining an online multi-window based GUI (Graphical User Interface), with a standardized point-and-click menu system, and window icon docking service, for Internet/Intranet web application ns incorporating HTML (Hyper Text Markup Language) and DHTML (Dynamic Hyper Text Markup Language)”.

### BACKGROUND OF THE INVENTION

The present invention relates to systems and methods used to distribute and manifest content received via the Internet and World Wide Web (WWW). More specifically, the present invention relates to the provision of a multi-window interface, allowing for a dynamic and interactive environment for accessing and manipulating data.

Computer networks, such as the Internet, have dramatically changed the way the people communicate with each other and get information about topics that interest them. The Internet and the World Wide Web (WWW) have become widely used and facilitated widespread distribution of vast amounts of information. However, the explosive volume of information available has lead to significant problems for users in terms of location and receiving desired content. Such problems are due in large part to the fact that while delivery technologies and systems have improved, the ability to organize, index, search and process content lags behind.

Known within the art are search and pull systems, and corresponding websites (e.g. Google). Given a collection of multiple systems, a Search Engine may be used to locate, find, compare, and track data as it relates to documents (including files, images, objects, programs and other data in various forms referred herein as a document) in the System(s). The Search Engine can read the documents through program(s) commonly referred to as a Web-walker, Web-crawler, Spider, Browser or Robot, which acts similar to a user and notes the words in a document, the words sequence and the size of the document If changes have occurred from a prior scan of the document, the date of the document, the file name, computer or server containing the document, the directory of the document, whether the document has a URL (universal record locator) pictures, objects (video, sound, etc.), attributes (color, font, etc.) links to other documents, meta-tags and any other attribute (spread sheets, graphs, computer code, programs, addresses of other documents and their associated attributes, etc.) that could be placed in or relate to the document.

Present Search Engines such as Google, Excite, and Alta Vista perform these following common functions: browsing of the documents by a program or system of programs to scan the documents for content and attributes; parsing of the documents to separate out words, information and attributes; indexing some or all of the words, information and attributes of the documents into a database; querying the index and database through a user interface (for live users and/or programs and systems) through local and remote access; maintaining the information, words and attributes in an index and database through data movement and management programs, as well as re-scanning the systems for documents, looking for changed documents, deleted documents, added documents, moved documents and new systems, files, information, connections to other systems and any other data and information.

Google represents a typical Search Engine. The Internet currently contains over one hundred million documents, each on average containing over 100 unique words with an average of over one unique word per document (the URL is usually also unique). This results in an extremely large database of words (over 100 million) and over 10 billion entries in a database that tracks words in referenced documents. As the Internet grows to more than a billion documents, these databases will grow respectively. In typical Internet Search Engine designs, Hash techniques, B-tree Indexes, sorted lists, and variations thereon are the current commonly accepted approaches. Such approaches generally provide the user with an exhaustive list of hyper-test links, which a network surfer may select by clicking, thus causing his web browser client application (e.g. Internet Explorer® and Netscape®) to go to the link.

Such systems have a number of problems, in addition to the great deal of time and frustration this process can place on the user. The present invention is concerned with the inability to view separate lists in separate windows. Currently, a search typically yields a long list of results, in which the user must constantly have to refresh the browser screen with the “next ten links” or scroll through a relatively large amount of text by using navigation buttons, scroll bars, browser application back and forward buttons, etc. This process can be extremely frustrating and take a significant amount of time.

Currently available web browser technologies and products do not effectively allow a network surfer to open a series of separate windows into which separate content streams may display corresponding information. For example, while an underlying operating system such as Microsoft Windows 98™ may support multiple windows each displaying the results of a different program, web browser tools and application remain relatively crude in terms of their native ability to present only static and exhaustive amounts of text and content in a single content review window or environment (e.g. a single web browser screen).

Previous attempts to solve this problem include providing web browsers which accept “plug-ins” and “helper” applications to provide for enriched content manifestation. Also, developers have begun to provide web content mixed with Java type code to enhance content review. Other solutions provide the launching of additional web browsers within an operating system to facilitate multiple window/browser application display of corresponding, separate content streams. One example of a portal website that seeks to ease content location and enrich content manifestation is www.mynetscape.com. Here network surfers can visit, receive content from a variety of sources and search the WWW, yet this is all still done from a single browser screen.

In the past, computer applications were programmed with reference to individual computers. With the rise in popularity of the Internet, computer programmers have steadily moved towards the design of applications and programs accessible via web browsers. In turn, a wide array of server-side computer languages has been developed to accommodate this new trend. As a result of this transition, there is a need within the art for a system that creates an adequate front-end interface for such web browser applications to match the functionality of applications created for the individual operating system and having a multi-window environment.

Nearly all previous systems and methods do not provide the ability to interface multiple browser or other interface multiple screens within a single application, allowing all windows to simultaneously display corresponding information. U.S. Pat. Nos. 6,272,493 6,321,209 6,434,563 and 6,535,882 teach a method of facilitating a multi windowed content manifestation coded in Pascal to perform a similar task. While the result of such code is quite similar, the distinguishing quality lies in the fact that Pascal is not a language supported by ASP.NET. The present subject of invention is specifically designed for use with ASP.NET as described herewith.

### SUMMARY OF THE INVENTION

The present invention relates to a system and method of providing an online multi-window based GUI with a standardized point and click menu system and window icon docking service for internet or intranet web applications incorporating HTML and DHTML.

It is envisioned that the present invention may be utilized as a system for transferring data across a network by means of a multi-window based GUI. The system further comprises a remote server, having at least one window module, .NET application, .NET framework, .NET development tools, an HTML beginning tag, an HTML ending tag and at least one ASPX tag. The remote server translates classes and objects into HTML/DHTML code by taking the ASPX tag and embedding HTML code to fit within the HTML beginning tag and HTML ending tag and then transferring the HTML/DHTML code across an electronic data network. The system also includes at least one client system coupled to the remote server through the electronic data network. The client system has a content retrieval module in communication with the remote server. The client system includes a windowed content manifestation environment. The client system also includes a web browser further comprising at least one window module and at least one interactive menu module embedded in each window module. The interactive menu module reacts to activation on the client system and posts back to the remote server, notifying the .NET application through a raised event.

Another object of the invention is a system for transferring data across a network by means of a multi-window based GUI. The system further comprises a remote server, having at least one window module, .NET application, NET framework, .NET development tools, an HTML beginning tag, an HTML ending tag and at least one ASPX tag. The remote server translates classes and objects into HTML/DHTML code by taking the ASPX tag and embedding HTML code to fit within the HTML beginning tag and the HTML ending tag and then transferring the data across an electronic data network. The system further comprises at least one client system coupled to the remote server through the electronic data network. The client system has a content retrieval module in communication with the remote server. The client system includes a windowed content manifestation environment. The client system also includes a web browser comprising at least one window module, at least one interactive menu module embedded in each window module and a window icon docking system. The interactive menu module reacts to actuation on the client system and posts back to the remote server and notifying the .NET application through a raised event. The window icon docking system is present within the web browser within the client system and is in communication with each window module.

A further object of the invention is an object-oriented method of developing a software system used in acquiring information from a remote server to a client system through a .NET environment using HTML/DHTML. The method comprises the step of defining at least two object types. Followed by the step of creating at least one window object on the remote server. The window object stores the programming code for generating dynamic HTML/DHTML context windows on the client system's web browser. Followed by the step of creating at least one interactive menu object on the client system. The at least one interactive menu object creates interactive, point and click menus from the programming code. The at least one menu object stores the programming code, from the client system. The programming code provides a set of steps that returns selections from a user to applications on the remote server by means of a post back method. Followed by the step of acquiring the programming code from the remote server to the client system according to a set of steps using at least two object types, at least one window object and at least one menu object. Finally executing the programming code on the client system.

Another object of the invention is an object-oriented method of developing a software system used in acquiring information from a remote server to a client system through a .NET environment using HTML/DHTML. The method comprises the step of defining at least three object types. Followed by the step of creating at least one window object on the remote server to store the programming code for generating dynamic HTML/DHTML context windows on the client system's web browser. Followed by the step of creating at least one interactive menu object on the client system. The interactive menu object creates interactive menus from the programming code. Followed by storing the programming code, from the client system. The programming code provides for a set of steps which return selections from the user to applications on the remote server by means of a post back method. Followed by the step of creating at least one dock object on the client system which is a DHTML scrolling layer holding clickable icons linked to context windows generated by the window object which have their state set to minimize. Followed by the step of acquiring the programming code from the remote server to the client system according to a set of steps using at least three object types, at least window object, at least one menu object and at least one dock object. Followed by executing the programming code on the client system.

Other objects and advantages of the present invention will become apparent from the descriptions in conjunction with the accompanying images, wherein, by way of illustration and example, an embodiment of the present invention is disclosed.

### BRIEF DESCRIPTION OF THE DRAWINGS

FIG. 1 is a diagram of a web/user interfacing system according to a preferred embodiment of the present invention;

FIG. 2 is block diagram of several components of an interface application according to a preferred embodiment of the present invention;

FIG. 3 is a block diagram of a relationship between components of an interface application according to a preferred embodiment of the current invention;

FIG. 4 is a screen image of a preferred embodiment of the current invention;

FIG. 5 is a screen image of a function of a preferred embodiment of the current invention;

FIG. 6 is a screen image of several components of an interface application in correlation with a web browser application according to a preferred embodiment of the current invention;

FIG. 7 is a screen image of a function panel according to a preferred embodiment of the current invention;

FIG. 8 shows a source code along with a resulting screen image indicating content according to a preferred embodiment of the current invention;

FIG. 9 shows a screen image resulting from a method of transferring content according to a preferred embodiment of the current invention;

FIG. 10 is a screen image resulting from a method of initializing a function of a preferred embodiment of the current invention;

FIG. 11 is flow chart depicting the steps for providing a system as disclosed in a preferred embodiment of the current invention; and

FIG. 12 is flow chart depicting the steps for providing a system as disclosed in a preferred embodiment of the current invention.

### DETAILED DESCRIPTION OF THE INVENTION

The following detailed description is of the preferred embodiments of the present invention. The description is not to be taken in a limiting sense, but is made merely for the purpose of illustrating the general principles of the invention, since the scope of the invention is best defined by the appended claims.

Turning now descriptively to the drawings, wherein similar reference numbers denote similar elements throughout the similar views, the attached figures denote a system for creating a computer interface between an individual operating system. Additionally, a method is depicted, providing for the manifesting and transferring of content within a system as described herein.

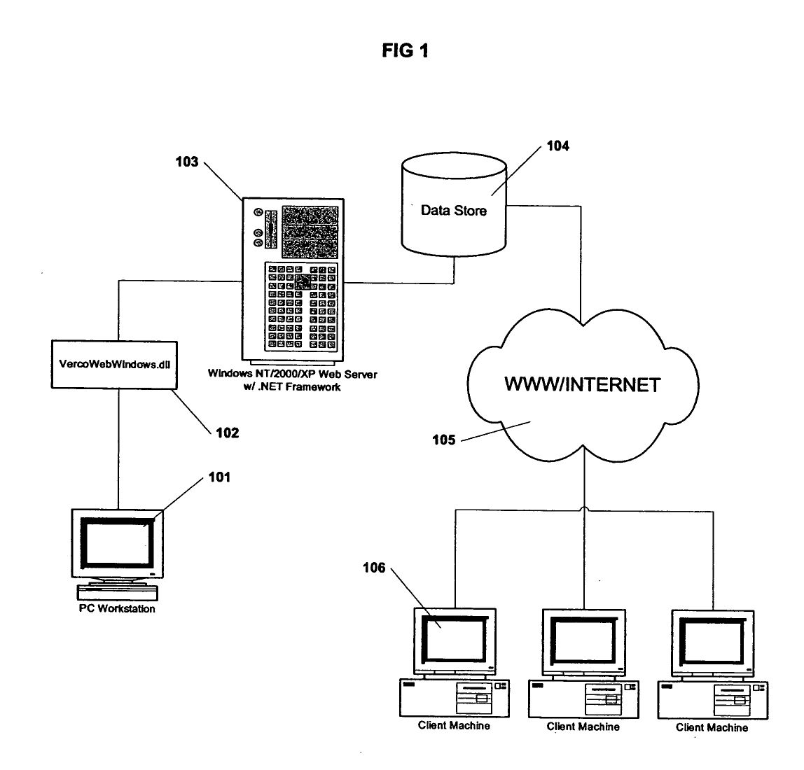

FIG. 1 depicts a global view of a preferred embodiment, which creates a programmable multi-window environment including, but not limited to, interactive menu modules embedded in the window module 102 and a window icon docking system. This is facilitated through the use of HTML and DHTML across a network 105 on a client system web browser, such as Internet Explorer. A PC Workstation 101 is used by a programmer or web developer who uses the components of the present invention in the assembly (VercoWebWindows.dll) 102 installed on the PC Workstation computer along with a .NET framework, .NET development tools and a .NET application installed on a remote server 103. With VercoWebWindows.dll 102 installed on the remote server 103 classes and objects from the present invention are translated into HTML/DHTML code which is transferred across a network 105, such as the World Wide Web or a company Intranet (optionally through a data store 104) and into client system(s) 106 with web browsers installed. Users of the application on the client system 106 are able to interact with the HTML/DHTML context windows generated, and have the state of the generated GUI (Graphical User Interface) is maintained and stored on the client system 106 as well as on the remote server 103 through a method called “post back.” This post back method holds data on the client system and at predetermined intervals sends or posts the data back to the remote server.

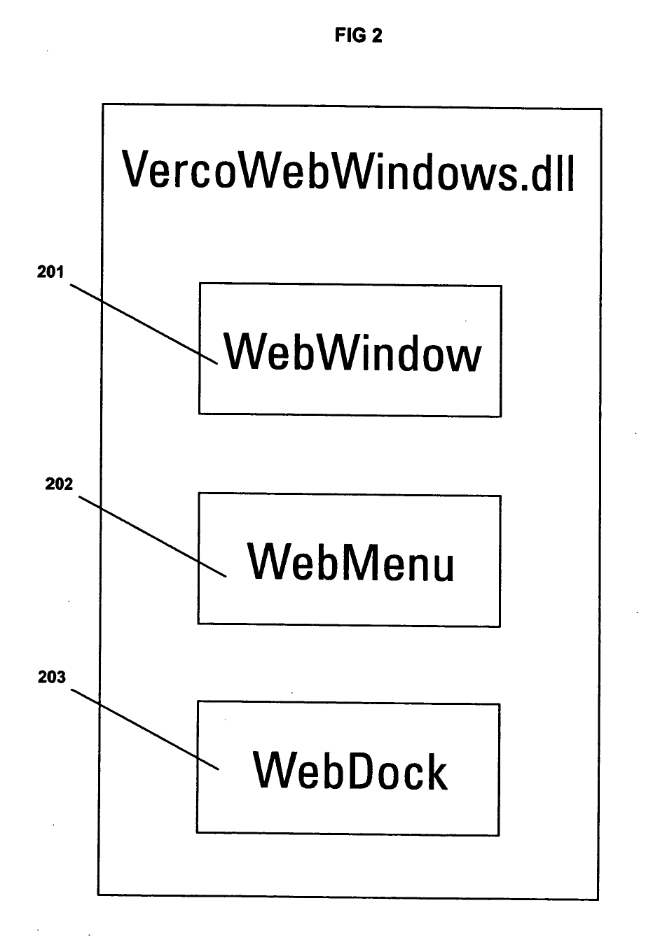

In FIG. 2 depicts block representations of the components that make up the present invention, three objects, which may be classes or “server controls.” The first object is a window module 201 called WebWindow, the second is an interactive menu module 202, called WebMenu, and the third is a window icon docking system 203, called WebDock. The window module object 201 is created on the remote server and stores the programming code for generating dynamic HTML/DHTML context windows on a client system web browser. The interactive menu module object 202 is responsible for creating interactive, point-and-click menus from HTML/DHTML and storing the client system code that returns selections from the user to the server application via “post back”. The window icon docking system object 203 is a DHTML scrolling layer that holds clickable icons that represent context windows created from an instance or multiple instances of the window module object, that have their state, which may be called WindowState, set to “Minimize”. Clicking on an icon in the window icon docking system object 203 DHTML layer causes the window icon docking system object 203 to change the state of the corresponding window module 201 to Normal, restoring the context window to regular view of the client system web browser.

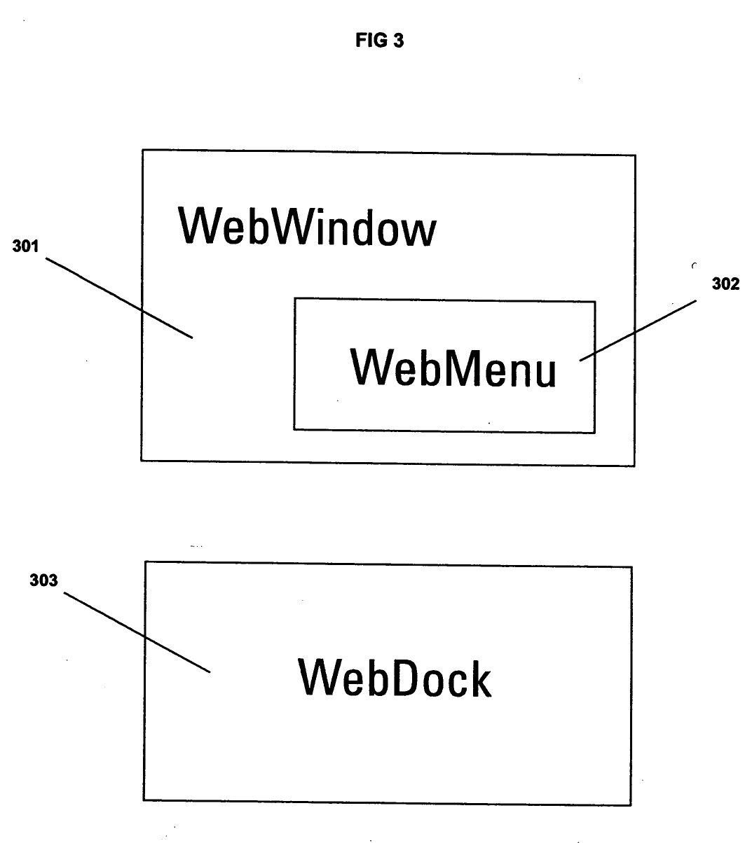

FIG. 3 shows the relationship between the components of the present invention in a block diagram. The window module object 301, which may be called WebWindow, may have a child component in it consisting of an interactive menu module object 302, which may be called WebMenu. The window module object 301 has a visible interactive menu module object 302 in it, consisting of DHTML layers, which move around with the actual context window created by the window module object 301. If the window module object 301 is moved or resized by the client system, allowing each instance of the HTML/DHTML context window created by the window module object 301 to have its own mouse-clickable menu. The window icon docking system object 303 is separate from the window module object 301 and interactive menu module object 302, and is optional. Utilization of the window icon docking system object 303 is not necessary in order to create the multi-windowed environment provided by the present invention.

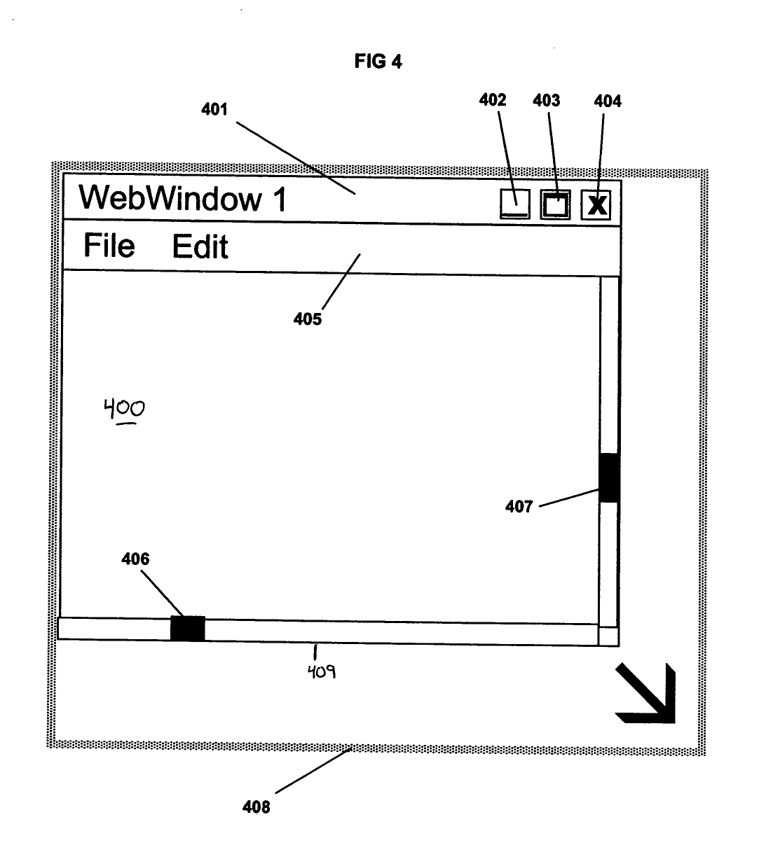

Depicted in FIG. 4, we see a representation of how a component of the present invention, the window module object 400, appears on the client system web browser screen 408. The HTML/DHTML generated window module consists of a title bar 401 that displays the title of the window (set on the server-side), a “minimize” button 402 that when actuated, changes the state, which may be called WindowState, to “minimized” visually collapsing the window, a “restore” or “maximize” button 403 that further changes the appearance of the window when clicked (“Restore” puts the window back in normal mode, which is how it appears in the figure. “Maximize” makes the window take up the entire space of the web browser screen, obscuring all other windows), and a “close” button 404, which when actuated causes a Javascript form submit that notifies the remote server application to prevent the window from being rendered. The embodiment of the context window optionally may also contain a horizontal scroll bar 406 and a vertical scroll bar 407 that alter the visible area of the HTML content inside of the window module object 400. Every window module object 400 also has an interactive and resizable border 409 which is expandable to the edge of the client system web browser screen 408. Resizing the border 409, on the client-side, makes the window module object 400 conform to its new dimensions. Storing the new dimensions of the window module object 400 on the client-side, which will be posted back to the remote server when a post back occurs, thus retaining the window module object's size between form submits.

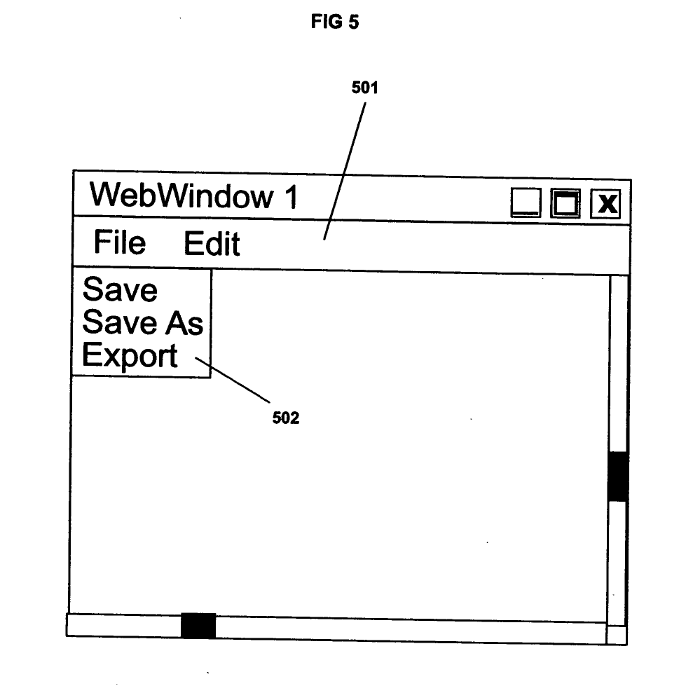

In FIG. 5 we see the interactive menu module object 501 as it is displayed on the client-side browser screen, embedded inside of the window module. The interactive menu module object 501, when rendered as a DHTML menu has menu items that react to actuation on the client-side. This actuation may be caused by a mouse movement or mousing actions. Upon actuating a menu item in the interactive menu module 501, if the interactive menu module item has children (or sub-menu items) they are displayed vertically underneath the parent interactive menu module object item in what may be called a “context menu” 502. Actuating an interactive menu module item without children, or children menu items causes the client-browser to “post back” to the server, and the .NET application on the server side is notified on the interactive menu module selection through a raised event.

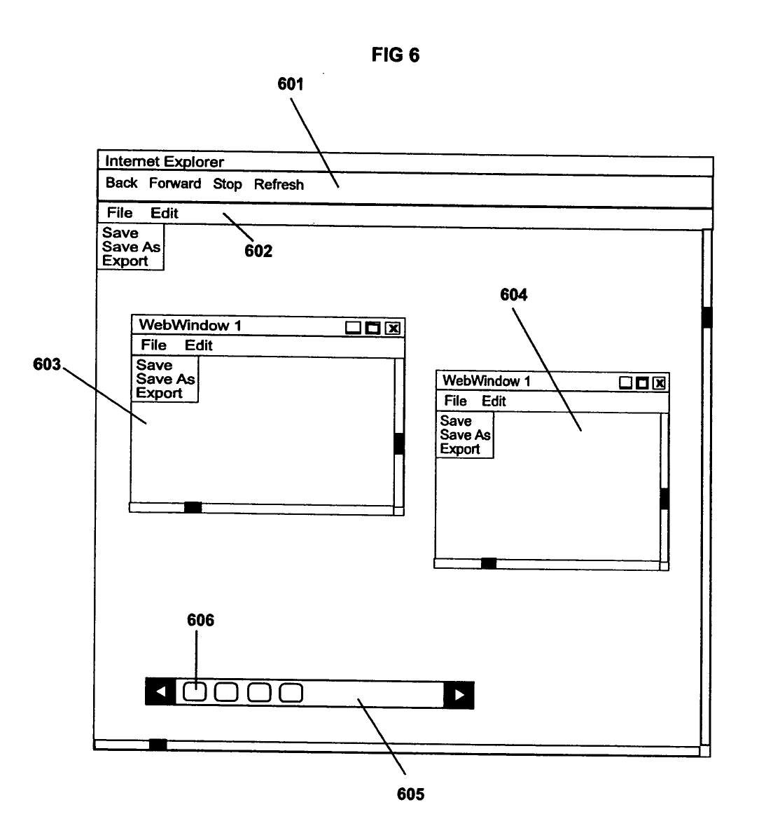

FIG. 6 shows the appearance of the present invention in a client system web browser 601, such as Internet Explorer from Microsoft Corporation, with a interactive menu module object 602 acting as the main menu for the entire application, and with multiple instances of the window module object 603, 604 all within the same client system web browser 601. Toward the bottom of the client system web browser 601 is a window icon docking system object 605 with mouse-clickable icons 606 representing window module objects that have their state set to “minimized” or “docked”, and exist within the window icon docking system object 605.

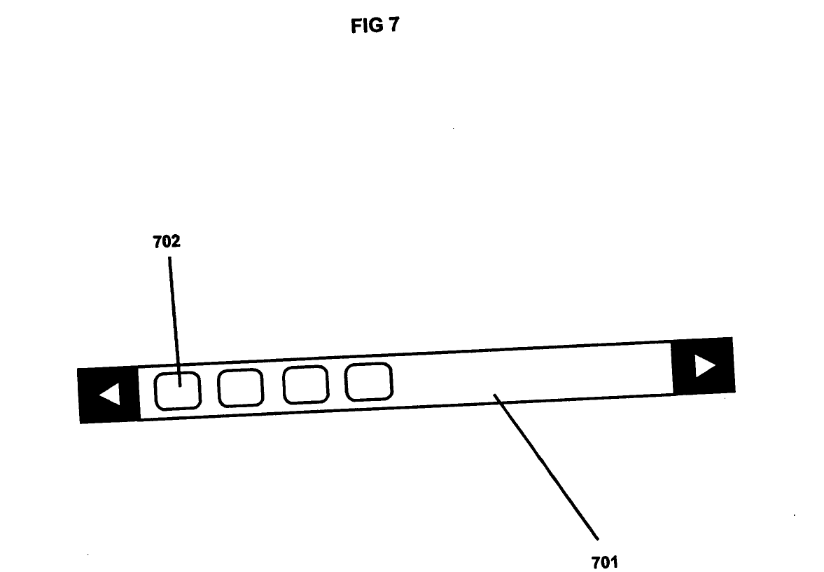

FIG. 7 depicts a closer view of the window icon docking system object 701, that when rendered in the client system web browser uses a scrollable CSS div layer to store window icons 702. The window icon docking system object 701 is allowed to scroll when the number of icons becomes too great to hold in the width of the window icon docking system object 701.

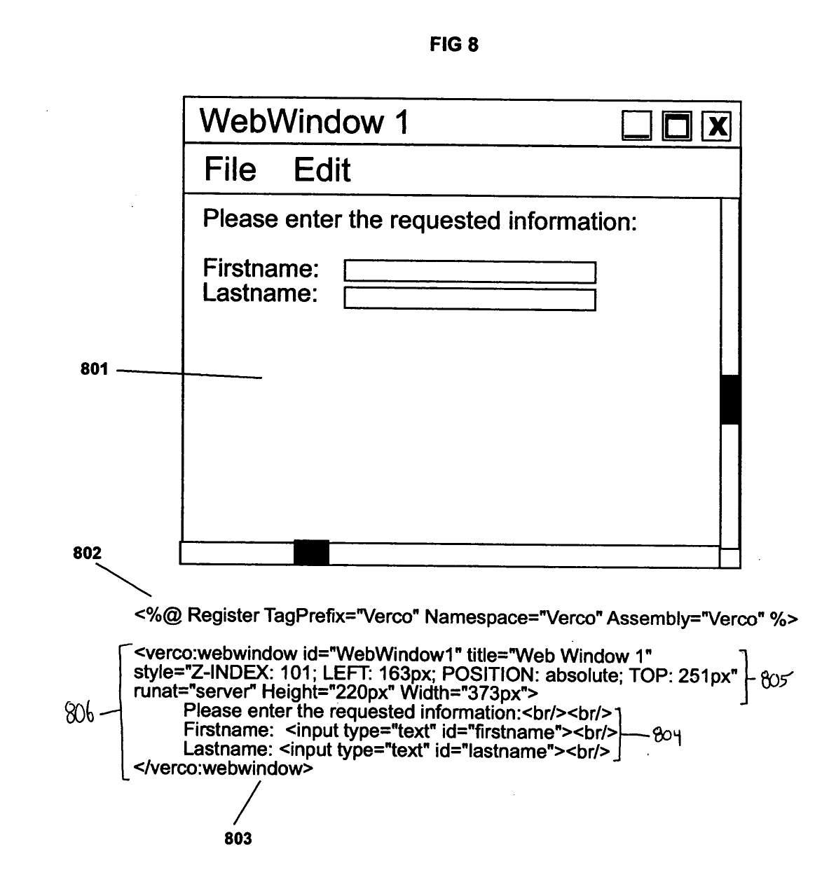

FIG. 8 depicts an example of how to populate the window module 801 generated by the remote server with HTML content, literally by taking the ASPX tag used to create the control programmatically (after the control is registered using the “Register” directive 802), and embedding HTML code and form object 804 inside the beginning tag 805 and ending tag 803 of the ASPX tag 806. The control parses all of the data inside of the beginning tag 805 and ending tag 803 and renders the HTML 804 included in the content area of the generated window module 801.

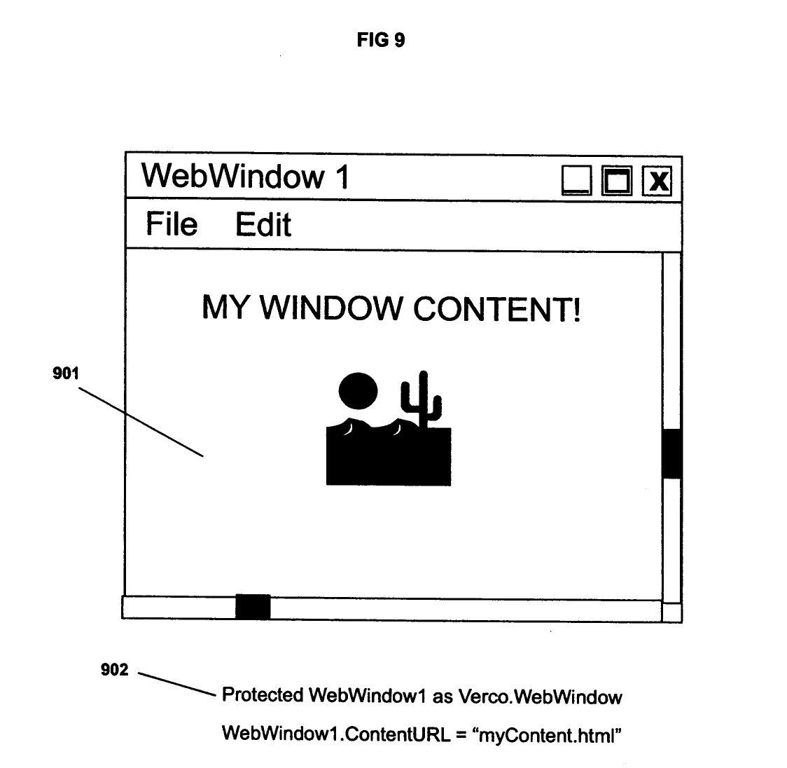

FIG. 9 demonstrates the window module 901 loading HTML elements that will be rendered in the window module 901, using the ContentURL property of the window module 901, which opens a file on the remote server, web server or a URL and reads data 902 from the data source, then renders the HTML data 902 inside of the bounds of the generated window module 901.

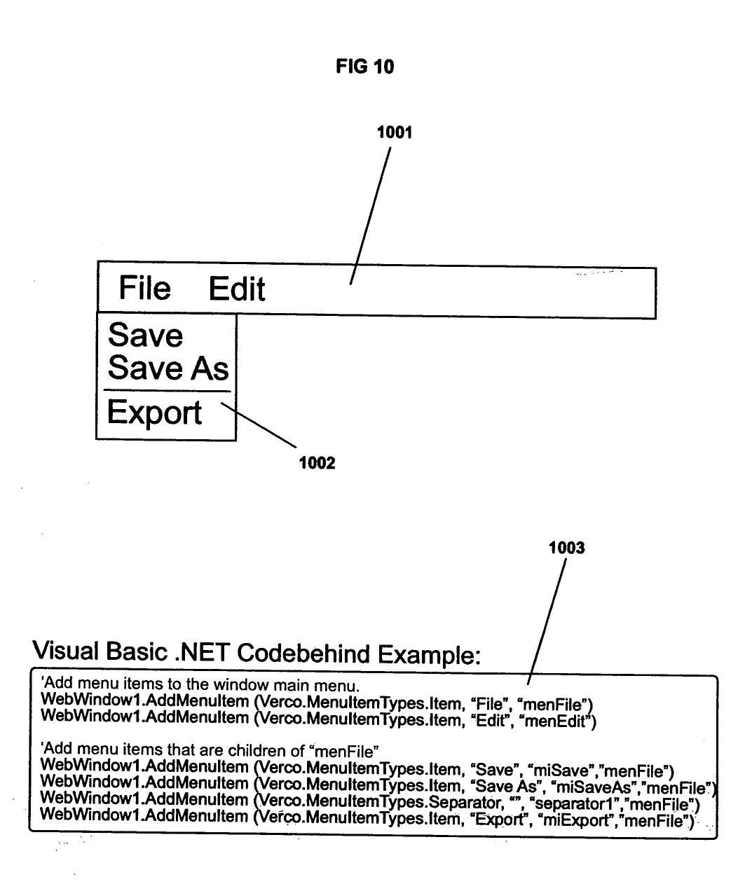

FIG. 10 demonstrates how the programmer can initialize the items 1002 of the interactive menu module object 1001, either embedded in the window module object or standalone, using the AddMenuItem method 1003. After executing the code for the AddMenuItem method 1003, the items 1002 within the interactive menu module object 1001 are initialized.

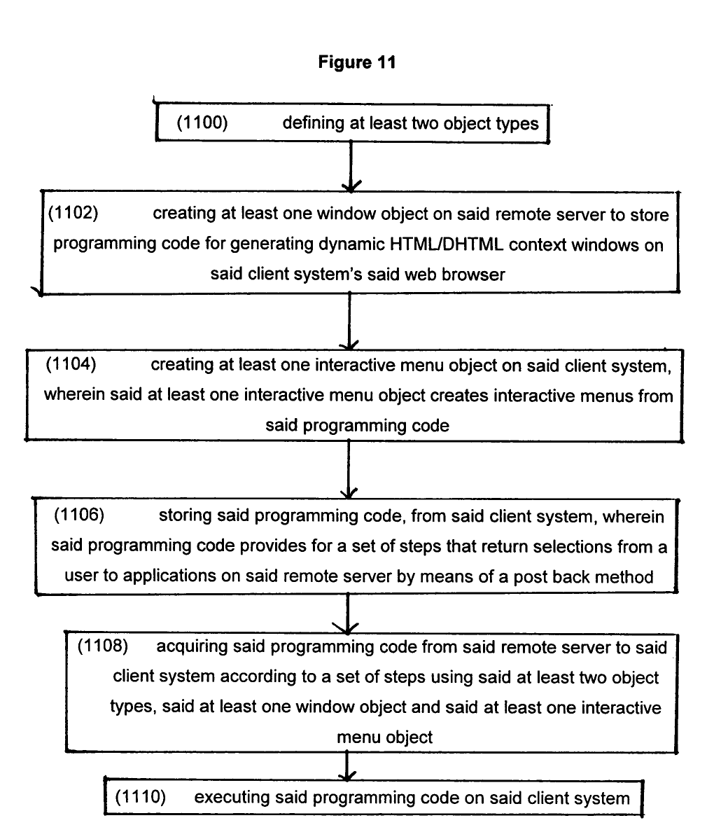

FIG. 11 shows the necessary steps for an object-oriented method of developing a software system, wherein at least one client system retrieves data from a remote server through a .NET environment using HTML/DHTML. The first step 1100 is to define at least two object types. These two object types in a preferred embodiment are a window object and an interactive menu object. Followed by the step 1102 of creating at least one window object on the remote server. This window object stores the programming code for generating dynamic HTML/DHTML context windows on the client system's web browser. This is followed by the step 1104 of creating at least one interactive menu object on the client system. This interactive menu object creates interactive menus from the programming code. This is followed by 1106 storing the programming code from the client system. The programming code provides for a set of steps that returns selections from a user to applications on the remote server by means of a post back method. The post back method involves retaining this data on the client system until the next predetermined post back, when the data is transferred back to the remote server. The following step 1108 acquires the programming code from the remote server to the client system according to the set of steps using at lease two object types, at least one window object and at lease one interactive menu object. The final step 1110 is that of executing the programming code on the client system.

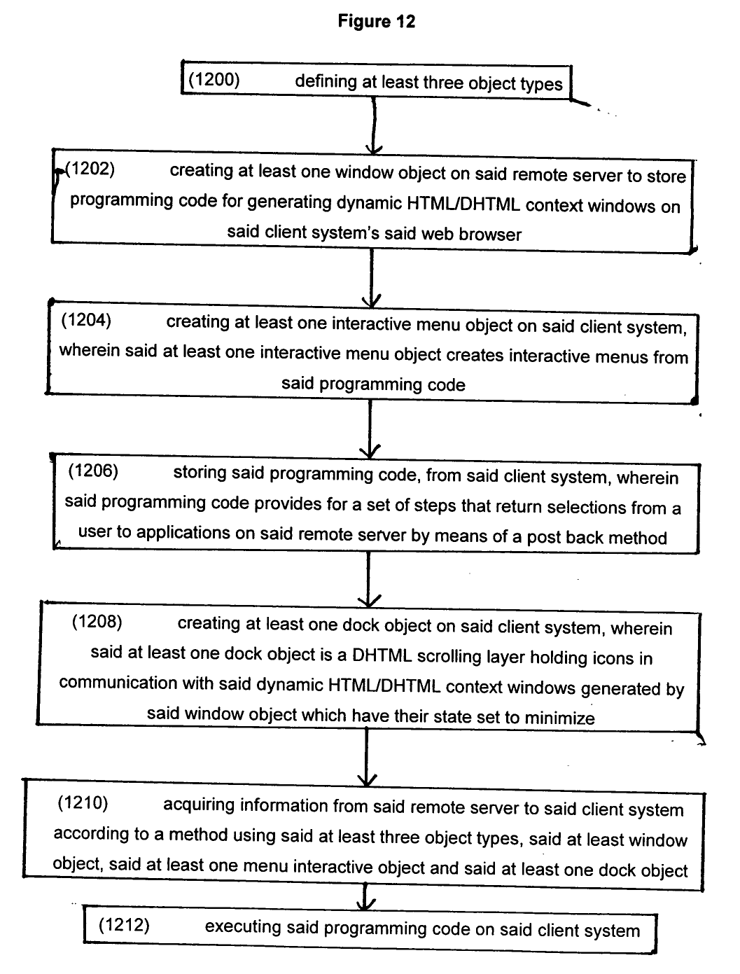

FIG. 12 shows the necessary steps for an object-oriented method of developing a software system, wherein at least one client system retrieves data from a remote server through a .NET environment using HTML/DHTML. The first step 1200 is to define at least three object types. These three object types in a preferred embodiment are a window object, an interactive menu object and a dock object. Followed by the step 1202 of creating at least one window object on the remote server. This window object stores the programming code for generating dynamic HTML/DHTML context windows on the client system's web browser. This is followed by the step 1204 of creating at least one interactive menu object on the client system. This interactive menu object creates interactive menus from the programming code. This is followed by 1206 storing the programming code from the client system. The programming code provides for a set of steps that returns selections from a user to applications on the remote server by means of a post back method. The post back method involves retaining this data on the client system until the next predetermined post back, when the data is transferred back to the remote server. The following step 1208 creates at lease one dock object on the client system. The dock object is a DHTML scrolling layer which holds icons in communication with the dynamic HTML/DHTML context windows generated by the window object which have their state set to minimize. The following step 1210 acquires the programming code from the remote server to the client system according to the set of steps using at lease two object types, at least one window object and at lease one interactive menu object. The final step 1212 is that of executing the programming code on the client system.

The following detailed description is of the preferred embodiments of the present invention. The description is not to be taken in a limiting sense, but is made merely for the purpose of illustrating the general principles of the invention, since the scope of the invention is best defined by the appended claims.

1. A system which transfers data across a network by means of a multi-window based GUI, comprising:
a remote server, having at least one window module, .NET application, .NET framework, .NET development tools, an HTML beginning tag, an HTML ending tag and at least one ASPX tag, wherein said remote server translates classes and objects into HTML/DHTML code by taking said ASPX tag and embedding HTML code to fit within said HTML beginning tag and said HTML ending tag and transferring said HTML/DHTML code across an electronic data network; and
at least one client system coupled to said remote server through said electronic data network, having a content retrieval module in communication with said remote server, wherein said at least one client system includes a windowed content manifestation environment; a web browser comprising at least one window module and at least one interactive menu module embedded in each said at least one window module, wherein each said at least one interactive menu module reacts to activation on client system and posts back to said remote server, notifying said .NET application through a raised event.

2. A system as in claim 1, further comprising a window icon docking system within said web browser within said client system, wherein said window icon docking system is in communication with each said at least one window module.

3. A system as in claim 2, further comprising a scrollable CSS div layer within said window icon docking system.

4. A system an in claim 1, further comprising at least one child component within said at least one window module.

5. A system as in claim 4, wherein said at least one child component is an interactive menu module.

6. A system as in claim 1, further comprising initialized menu items within said interactive menu module.

7. A system for transferring data across a network by means of a multi-window based GUI, further comprising:
a remote server, having at least one window module, .NET application, .NET framework, .NET development tools, an HTML beginning tag, an HTML ending tag and at least one ASPX tag, wherein said remote server translates classes and objects into HTML/DHTML code by taking said ASPX tag and embedding HTML code to fit within said HTML beginning tag and said HTML ending tag and transferring said HTML/DHTML code across an electronic data network; and
at least one client system coupled to said remote server through said electronic data network, having a content retrieval module in communication with said remote server, wherein said at least one client system includes a windowed content manifestation environment; a web browser comprising at least one window module, at least one interactive menu module embedded in each said at least one window module and a window icon docking system, wherein each said at least one interactive menu module reacts to activation on client system and posts back to said remote server, notifying said .NET application through a raised event, said window icon docking system is present within said web browser within said client system, wherein said window icon docking system is in communication with each said at least one window module.

8. A system as in claim 7, further comprising a scrollable CSS div layer within said window icon docking system.

9. A system as in claim 7, wherein said interactive menu modules are embedded in each said at least one window module.

10. A system an in claim 7, further comprising a child component within said at least one window module.

11. A system as in claim 10, wherein said child component is a menu module.

12. A system as in claim 7, further comprising at least one initialized menu item within said at least one interactive menu module.

13. An object-oriented method of developing a software system, wherein at least one client system retrieves data from a remote server through a .NET environment using HTML/DHTML comprising the following steps:
defining at least two object types;
creating at least one window object on said remote server to store programming code for generating dynamic HTML/DHTML context windows on said client system's said web browser;
creating at least one interactive menu object on said client system, wherein said at least one interactive menu object creates interactive menus from said programming code;
storing said programming code, from said client system, wherein said programming code provides for a set of steps that return selections from a user to applications on said remote server by means of a post back method;
acquiring said programming code from said remote server to said client system according to a set of steps using said at least two object types, said at least one window object and said at least one interactive menu object; and
executing said programming code on said client system.

14. A method as defined in claim 13, further comprising the step of:
creating at least one dock object on said client system, wherein said at least one dock object is a DHTML scrolling layer holding icons in communication with said dynamic HTML/DHTML context windows generated by said window object which have their state set to minimize.

15. A method as defined in claim 13, further comprising the step of including a scrollable CSS div layer within said at least one dock object.

16. A method as defined in claim 13, further comprising the step of creating a child component in said at least one window object.

17. A method as defined in claim 16, wherein said child component is an interactive menu object.

18. A method as defined in claim 13, further comprising the steps of:
modifying said at least one window object on said client system; and
posting said modification back to said remote server at a predetermined time interval.

19. A method as defined in claim 18, wherein said step of modifying said at least one window object is chosen from the group of translation, resizing, collapsing, expansion, closing, minimizing, maximizing and restoring.

20. A method as defined in claim 13, further comprising the steps of:
modifying said at least one window object on said remote server to create a modification; and
posting said modification back to said remote server at a predetermined time interval.

21. A method as defined in claim 20, wherein said step of modifying said at least one window object is selected from the group of translation, resizing, collapsing, expansion, closing, minimizing, maximizing and restoring.

22. A method as defined in claim 13, further comprising the step of horizontally scrolling through content manifested within said at least one window object.

23. A method as defined in claim 13, further comprising the step of vertically scrolling through the content within said at least one window object by said user.

24. A method as defined in claim 13, further comprises the step of posting back to said remote server the resultant action of a raised event within said at least one menu object on said client system.

25. A method as defined in claim 13, further comprising the step of initializing items within said at least one menu object.

26. An object method of developing a software system wherein at least one client system retrieves data from a remote server through a .NET environment using HTML/DHTML comprising the following steps:
defining at least three object types;
creating at least one window object on said remote server to store programming code for generating dynamic HTML/DHTML context windows on said client system's said web browser;
creating at least one interactive menu object on said client system, wherein said at least one interactive menu object creates interactive menus from said programming code;
storing said programming code, from said client system, wherein said programming code provides for a set of steps that return selections from a user to applications on said remote server by means of a post back method;
creating at least one dock object on said client system, wherein said at least one dock object is a DHTML scrolling layer holding icons in communication with said dynamic HTML/DHTML context windows generated by said window object which have their state set to minimize;
acquiring said programming code from said remote server to said client system according to a set of steps using said at least three object types, said at least one window object, said at least one interactive menu object and said at least one dock object; and
executing said programming code on said client system.

27. A method as defined in claim 26, further comprising the step of including a scrollable CSS div layer within said at least one dock object.

28. A method as defined in claim 26, further comprising the step of creating a child component in said at least one window object.

29. A method as defined in claim 28, wherein said child component is an interactive menu object.

30. A method as defined in claim 26, further comprising the steps of:
modifying said at least one window object on said client system; and
posting said modification back to said remote server at a predetermined time interval.

31. A method as defined in claim 30, wherein said step of modifying said at least one window object is chosen from the group of translation, resizing, collapsing, expansion, closing, minimizing, maximizing and restoring.

32. A method as defined in claim 26, further comprising the steps of:
modifying said at least one window object on said remote server to create a modification; and
posting said modification back to said remote server at a predetermined time interval.

33. A method as defined in claim 32, wherein said step of modifying said at least one window object is selected from the group of translation, resizing, collapsing, expansion, closing, minimizing, maximizing and restoring.

34. A method as defined in claim 26, further comprising the step of horizontally scrolling through content manifested within said at least one window object.

35. A method as defined in claim 26, further comprising the step of vertically scrolling through the content within said at least one window object by a user.

36. A method as defined in claim 26, further comprising the step of posting back to said remote server the resultant action of a raised event within said at least one menu object on said client system.

37. A method as defined in claim 26, further comprising the step of initializing items within said at least one menu object.
